(19) United States
(12) Patent Application Publication
(10) Pub. No.: US 2024/0259904 A1
(43) Pub. Date: Aug. 1, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Xin YOU, Dongguan (CN)

(73) Assignee: GUANGDONG OPPO MOBILE TELECOMMUNICATIONS CORP., LTD., Dongguan (CN)

(21) Appl. No.: 18/634,274

(22) Filed: Apr. 12, 2024

Related U.S. Application Data
(63) Continuation of application No. PCT/CN2021/124187, filed on Oct. 15, 2021.

(51) Int. Cl. H04W 36/30; H04W 36/08

(52) U.S. Cl. CPC H04W 36/30; H04W 36/08

(57) ABSTRACT

A wireless communication method, a terminal device, and a network device are disclosed. The wireless communication method includes activating, by a terminal device, a first transmission reception point (TRP) of at least one TRP in response to a first condition being satisfied; wherein the first condition comprises at least one of: indication information that is configured to indicate activating the first TRP being received; and channel quality of the first TRP being greater than or equal to a first threshold.

### CROSS REFERENCE TO RELATED APPLICATIONS

The present application is a continuation application of the international patent application No. PCT/CN2021/124187, filed on Oct. 15, 2021, and contents of which are incorporated herein by its entireties.

### TECHNICAL FIELD

The present disclosure relates to the field of communication, and in particular to a wireless communication method, a terminal device, and a network device.

### RELATED ART

In a new radio (NR) system, a switching process of a connected-state terminal is supported, and the switching is configured based on a terminal performing measurement and reporting the measurement and based on a network. However, a delay of the switching is large. Therefore, how to reduce the delay of the switching is an urgent problem to be solved.

### SUMMARY OF THE DISCLOSURE

In a first aspect, a wireless communication method is provided and includes: activating, by a terminal device, a first transmission reception point (TRP) of at least one TRP in response to a first condition being satisfied.

The first condition comprises at least one of: an indication information that is configured to indicate activating the first TRP being received; and channel quality of the first TRP being greater than or equal to a first threshold.

In a second aspect, a terminal device is provided and includes a processor and a memory. The memory stores a computer program, and the processor invokes and runs the computer program stored in the memory to perform the method in the first aspect.

In a third aspect, a network device is provided and includes a processor and a memory. The memory stores a computer program, and the processor invokes and runs the computer program stored in the memory to perform sending first indication information to a terminal device, wherein the first indication information is configured to indicate the terminal device to activate a first transmission reception point (TRP) of at least one TRP.

### BRIEF DESCRIPTION OF THE DRAWINGS

FIG. 1 is a schematic view of an architecture of a communication system according to an embodiment of the present disclosure.

FIG. 2 is a schematic view of a switching process according to an embodiment of the present disclosure.

FIG. 3 is a flow chart of a wireless communication method according to an embodiment of the present disclosure.

FIG. 4 is a flow chart of another wireless communication method according to an embodiment of the present disclosure.

FIG. 5 is a schematic view of a terminal device according to an embodiment of the present disclosure.

FIG. 6 is a schematic view of a network device according to an embodiment of the present disclosure.

FIG. 7 is a schematic view of a communication device according to an embodiment of the present disclosure.

FIG. 8 is a schematic view of an apparatus according to an embodiment of the present disclosure.

FIG. 9 is a schematic view of a communication system according to an embodiment of the present disclosure.

### DETAILED DESCRIPTION

Technical solutions in the embodiments of the present disclosure will be described below by referring to the accompanying drawings in the embodiments of the present disclosure. Obviously, the described embodiments are a part of, but not all of, the embodiments of the present disclosure. All other embodiments, which are obtained by any ordinary skilled person in the art based on the embodiments in the present disclosure without making creative work, shall fall within the scope of the present disclosure.

The technical solutions of the embodiments of the present disclosure may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an NR evolution system, an LTE-based access to unlicensed spectrum (LTE-U) system, an NR-based access to unlicensed spectrum (NR-U) system, and a non-terrestrial network (NTN) system, a universal mobile telecommunication system (UMTS), a wireless local area network (WLAN), Internet of things (IoT), Wireless Fidelity (Wi-Fi), 5th-Generation (5G) systems, or other communication systems.

Generally, a traditional communication system supports a limited number of connections, which may be achieved easily. However, as the communication technology develops, a mobile communication system supports not only traditional communication but also, such as, device to device (D2D) communication, machine to machine (M2M) communication, machine type communication (MTC), vehicle to vehicle (V2V) communication, or vehicle to everything (V2X) communication, and so on. The embodiments of the present disclosure may also be applied to the above communication systems.

In some embodiments, the communication system in the embodiments of the present disclosure may be applied in a carrier aggregation (CA) scenario, or in a dual connectivity (DC) scenario, or in a standalone (SA) deployment scenario.

In some embodiments, the communication system in the embodiments of the present disclosure may be applied to an unlicensed spectrum. The unlicensed spectrum may be referred to as a shared spectrum. Alternatively, the communication system in the embodiments of the present disclosure may also be applied to a licensed spectrum, and the licensed spectrum may be referred to as an unshared spectrum.

The present disclosure describes various embodiments by referring to a network device and a terminal device. The terminal equipment may also be referred to as a user equipment (UE), an access terminal, a user unit, a user station, a mobile station, a mobile platform, a remote station, a remote terminal, a mobile device, a user terminal, a terminal, a wireless communication device, a user agent, or a user apparatus, and so on.

The terminal device may be a station (ST) in the WLAN and may be a cellular telephone, a cordless telephone, a session initiation protocol (SIP) telephone, a wireless local loop (WLL) station, a personal digital assistant (PDA) device, a handheld device having wireless communication capabilities, a computing device or other processing devices connected to a wireless modem, an in-vehicle device, a wearable device, a terminal device in a next-generation communication system such as the NR network, or a terminal device in a future-evolved public land mobile network (PLMN), and so on.

In the embodiments of the present disclosure, the terminal device may be deployed on land, including indoors or outdoors, hand-held, wearable, or vehicle-mounted; or may be deployed on water (such as on ships and so on); or deployed in the air (such as on airplanes, balloons, satellites, and so on).

In the embodiments of the present disclosure, the terminal device may be a mobile phone, a tablet computer (Pad), a computer having a wireless transceiver function, a virtual reality (VR) terminal device, an augmented reality (AR) terminal device, a wireless terminal device in industrial control, a wireless terminal device in self-driving, a wireless terminal device in remote medical care, a wireless terminal device in a smart grid, a wireless terminal device in transportation safety, a wireless terminal device in a smart city or a smart home, an in-vehicle communication device, a wireless communication chip/application specific integrated circuit (ASIC)/system on chip (SoC), and so on.

As an example and not a limitation, in the embodiments of the present disclosure, the terminal device may alternatively be a wearable device. The wearable device, which may also be referred to as a wearable smart device, is a general term for applying the wearable technology to intelligently design and develop devices that can be worn daily, such as glasses, gloves, watches, clothes, and shoes. The wearable device is a portable device that is worn directly on the body or integrated into the user's clothes or accessories. The wearable device is not only a hardware device, but may achieve powerful functions through software support, data interaction and cloud interaction. Broadly speaking, the wearable smart devices include a device that is full-featured and large-sized, and achieves complete or partial functions without relying on a smart phone, such as a smart watch or smart glasses, and so on. The wearable smart devices further include a device that focuses on a certain type of application function and needs to be used cooperatively with other devices, such as a smart bracelet or a smart jewelry that are used to monitor physical signs and symptoms.

In the embodiments of the present disclosure, the network device may be a device for communicating with a mobile device. The network device may be an access point (AP) in the WLAN; a base transceiver station (BTS) in the GSM or the CDMA; or a NodeB (NB) in the WCDMA; or an evolutional Node B (eNB or eNodeB) in the LTE; or a relay station or an access point; or a network device or a base station (gNB) in the in-vehicle device, in the wearable device, and in the NR network; or a network device in the future evolved PLMN network or in the NTN; and so on.

As an example and not a limitation, in the embodiments of the present disclosure, the network device may be mobile, for example, the network device may be a mobile device. In some embodiments, the network device may be a satellite, a balloon station. For example, the satellite may be a low earth orbit (LEO) satellite, a medium earth orbit (MEO) satellite, a geostationary earth orbit (GEO) satellite, a high elliptical orbit (HEO) satellite, and so on. In some embodiments, the network device may also be a base station set up on land, in water, and so on.

In the embodiments of the present disclosure, the network device may provide services for a cell. The terminal device communicates with the network device through transmission resources (such as frequency domain resources or in other words spectrum resources) used by the cell. The cell may be a cell corresponding to the network device (such as, a base station). The cell may belong to a macro base station, or a base station corresponding to a small cell. The small cell includes: a metro cell, a micro cell, a pico cell, a femto cell, and so on. These small cells have a small coverage area and a low transmission power, and are suitable for providing high speed data transmission services.

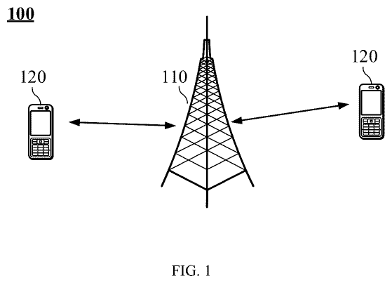

Exemplarily, the communication system 100 in the embodiments of the present disclosure is shown in FIG. 1. The communication system 100 may include a network device 110, and the network device 110 may be a device that communicates with a terminal device 120 (or referred to as a communication terminal, a terminal). The network device 110 may provide communication coverage for a specific geographic area and may communicate with a terminal device that is located within the coverage area.

FIG. 1 exemplarily illustrates one network device and two terminal devices. In some embodiments, the communication system 100 may include a plurality of network devices. Various numbers of terminal devices may be located within the coverage area of each of the plurality of network devices. The numbers of devices are not limited herein.

In some embodiments, the communication system 100 may further include other network entities, such as a network controller, a mobility management entity, and so on, which are not limited herein.

It should be understood that a device having communication functions in the network/system of the present disclosure may be referred to as a communication device. Taking the communication system 100 illustrated in FIG. 1 as an example, the communication device may include a network device 110 and a terminal device 120 having a communication function. The network device 110 and the terminal device 120 may be the devices as described in the above, which will not be repeated herein. The communication device may further include other devices in the communication system 100, such as the network controller, the mobility management entity, which will not be limited herein.

It should be understood that the terms “system” and “network” are often used interchangeably herein. The term “and/or” herein is merely a description of an association relationship between associated objects, indicating three kinds of relationships. For example, A and/or B may mean that: A is present alone, A and B are present at the same time, and B is present alone. In addition, the character “/” herein generally indicates that the object before the character “or” the object after the character.

Some terms used in the embodiments of the present disclosure are used only to explain specific embodiments of the present disclosure and are not intended to limit the present disclosure. The terms “first”, “second”, “third”, “fourth”, and so on in the specification, claims and the accompanying drawings are used to distinguish different objects, instead of indicating a particular order of the objects. In addition, the terms “comprising”, “having”, and any variations thereof, are intended to cover non-exclusive inclusion.

It should be understood that the “indication” in the embodiments of the present disclosure may be a direct indication, an indirect indication, or an indication of an associated relationship. For example, A indicating B means that: A directly indicates B, for example, B can obtain information from A; or A indirectly indicates B, for example, A indicates C, and B obtains information from C; or there is an association relationship between A and B.

In the embodiments of the present disclosure, the term “corresponding” may indicate a direct or indirect corresponding relationship between the two objects, or indicate an associated relationship between the two objects, or indicate indicating and being indicated, configuring and being configured, and so on.

In the embodiments of the present disclosure, “predefined” or “pre-configured” may be achieved by storing, in advance in a device (including the terminal device and the network device), corresponding codes, corresponding forms, or other means that can indicate relevant information. The present application does not limit the specific way of achieving the predefining or the pre-configuring. For example, the predefining may refer to a rule defined in a protocol.

In the embodiments of the present disclosure, the “protocol” may refer to standard protocols in the technical field of communication. For example, the protocol may include the LTE protocol, the NR protocol, and any relevant protocol applied in future communication systems, which will not be limited by the present disclosure.

In order to facilitate understanding of the technical solutions of the embodiments of the present disclosure, the technical solutions of the present disclosure are described in detail below based on specific embodiments. The following technologies in the related art are optional solutions and can be arbitrarily combined with the technical solutions of the embodiments of the present disclosure. All combined technical solutions shall fall within the scope of the embodiments of the present disclosure. The embodiments of the present disclosure include at least some of the following.

To facilitate a better understanding of the embodiments of the present disclosure, the switching in the present disclosure is described.

Similar to the LTE system, the NR system supports a switching process of a connected-state UE. When a user, who is using a network service, moves from one cell to another cell, or when the system has to transfer a communication link of the user from an original cell to a new cell (due to adjustment of wireless transmission service loads, activation operation maintenance, and device failure) to ensure communication continuity and service quality, the switching process is performed.

Taking a switching process of an Xn interface as an example, the switching process includes following three stages.
(1) Switching preparation: The switching preparation includes measurement control and reporting, switching requesting, and switching confirmation. A switching confirmation message includes a switching command generated by a target cell. A source cell is not allowed to make any modification to the switching command generated by the target cell and directly forwards the switching command to the UE.
(2) Switching execution: The UE performs the switching process immediately after receiving the switching command. That is, the UE disconnects from the source cell and connects to the target cell (for example, the UE performs random access, sends a radio resource control (RRC) switching-completion message to a target base station, and so on); a sequence number (SN) state is transferred; and data is forwarded.
(3) Switching completion: The target cell performs a path switch with an access and mobility management function (AMF) entity and a user plane function (UPF) entity and releases a UE context of the source BTS.

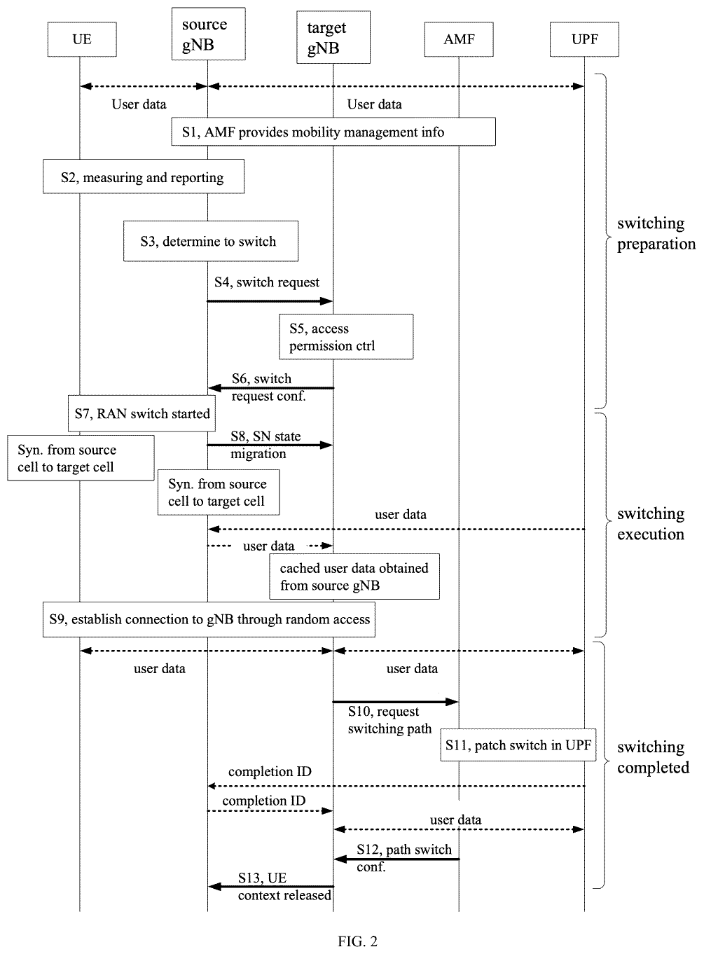

Specifically, as shown in FIG. 2, the switching may be achieved by performing the following operations S1 to S13.

In an operation S1, the AMF entity provides mobility control information.

In an operation S2, measurement and reporting is performed.

In an operation S3, the source gNB decides to perform the switching.

In an operation S4, the source gNB sends a switching request to a target gNB.

In an operation S5, the target gNB performs access permission control.

In an operation S6, the target gNB sends a switching request acknowledgement (ACK) to the source gNB.

In an operation S7, the UE and the source gNB starts performing radio access network (RAN) switching.

In an operation S8, the source gNB sends SN state migration to the target gNB.

In an operation S9, connection with the target gNB is established via random access.

In an operation S10, the target gNB sends a path switch request to the AMF entity.

In an operation S11, path switching is performed in the UPF entity.

In an operation S12, the AMF entity sends a path switching request acknowledgement to the target gNB.

In an operation S13, the target gNB sends a UE context releasing message to the source gNB.

To facilitate better understanding of the embodiments of the present disclosure, the technical problems to be solved by the present disclosure are described.

The switching is configured based on the terminal performing measurement and reporting and the network. Interaction of a plurality of signalings causes a large delay. Accordingly, the present disclosure provides a switching technical solution based on an underlying signaling, enabling the terminal device to perform the switching by activating or de-activating a transmission reception point (TRP).

The technical solutions of the present disclosure are described in detail in the following based on specific embodiments.

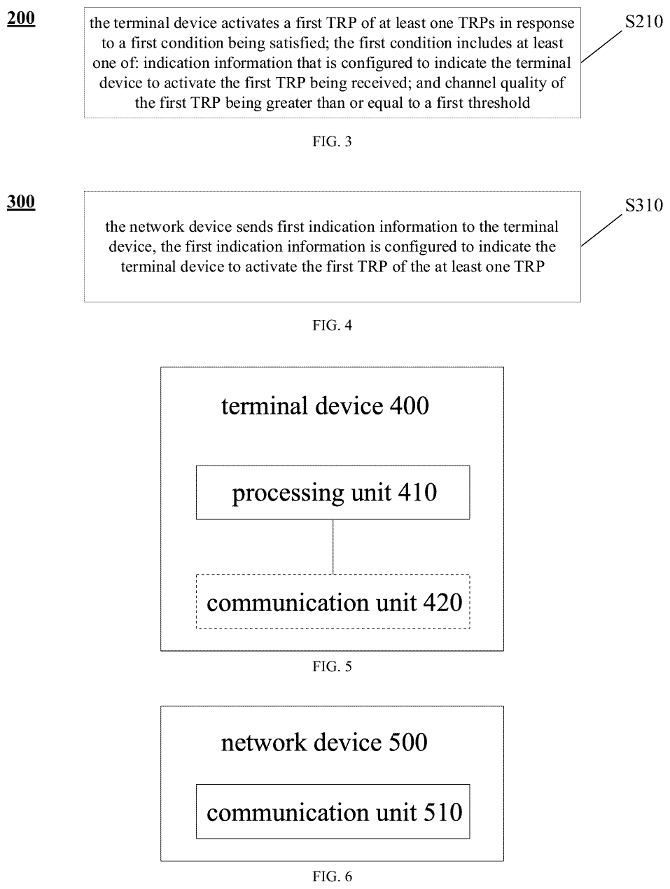

FIG. 3 is a flow chart of a wireless communication method 200 according to an embodiment of the present disclosure. As shown in FIG. 3, the wireless communication method 200 may include at least some of the following operations.

In an operation S210, the terminal device activates a first TRP of at least one TRPs in response to a first condition being satisfied.

The first condition includes at least one of: indication information that is configured to indicate the terminal device to activate the first TRP being received; and channel quality of the first TRP being greater than or equal to a first threshold.

In the embodiments of the present disclosure, the terminal device activates the first TRP of the at least one TRP in response to receiving the indication information configured to indicate the terminal device to activate the first TRP. Alternatively, the terminal device activates the first TRP of the at least one TRP in response to the channel quality of the first TRP being greater than or equal to the first threshold.

In some embodiments, the first threshold is configured by the network device or, determined by the protocol.

In some embodiments, the indication information that is configured to indicate the terminal device to activate the first TRP is carried via downlink control information (DCI) or a media access control control element (MAC CE). Alternatively, the DCI or the MAC CE further includes at least one of the following: a service cell identifier, a band width part (BWP) identifier, an identifier of the first TRP, and beam information corresponding to the first TRP. For example, the beam information includes at least one of the following: a transmission configuration indicator (TCI) state, a synchronization signal block (SSB), a channel state information reference signal (CSI-RS), and a sounding reference signal (SRS).

That is, in the embodiments of the present disclosure, the indication information that is configured to indicate the terminal device to activate the TRP is carried via an underlying signaling having less delay and more flexibility.

In some embodiments, the indication information that is configured to indicate the terminal device to activate the TRP is determined based on a channel measurement result for the at least one TRP that is reported by the terminal device.

In some embodiments, the at least one TRP may be configured by the network device.

In some embodiments, the terminal device receives first information. The first information includes: configuration information of the at least one TRP and/or state information of the at least one TRP. The state information is configured to indicate that a corresponding TRP is initially in an activated state or in a de-activated state after the configuration.

For example, the terminal device receives the first information sent by the network device.

Specifically, for example, the state information may be as shown in Table 1, but of course, Table 1 is only one form to show the state information, and the state information may alternatively be expressed in a manner similar to that in the Table 1, which will not be limited by the present disclosure.

TABLE 1

| TRP identifier | Initial state |
|---|---|
| 0 | activated |
| 1 | De-activated |
| 2 | De-activated |
| . . . | . . . |
| N − 1 | De-activated |

In some embodiments, the first information may be carried via one of the following:
the RRC, the DCI, and the MAC CE.

For example, the first information may occupy one or more elements in the signaling that carries the first information. Alternatively, the first information may occupy one or more fields in the signaling that carries the first information. Alternatively, the first information may occupy one or more domains in the signaling that carries the first information.

In some embodiments, when the configuration information of the at least one TRP includes timing advance (TA) configuration, the terminal device may omit an uplink synchronization process after activating the first TRP.

In some embodiments, the terminal device performs channel quality monitoring on the configured at least one TRP. Alternatively, the terminal device reports the channel quality of the at least one TRP.

In some embodiments, the terminal device performs the channel quality monitoring and channel quality reporting based on configuration of the network device. For example, the network device may configure a measurement object (the reference signal, the cell identifier, and so on), a reporting time, and a reporting period. In some embodiments, the measurement result for the at least one TRP may be reference signal received quality (RSRQ), or a reference signal received power (RSRP), or a signal to interference to noise ratio (SINR).

In some embodiments, when the number of the at least one TRP is greater than or equal to 2, different TRPs in the at least one TRP belong to different cells. Alternatively, different TRPs in the at least one TRP belong to a same cell. Alternatively, different TRPs in the at least one TRP correspond to different cell identifiers. Alternatively, different TRPs in the at least one TRP correspond to a same cell identifier.

For example, the cell identifier is a physical cell identifier (PCI).

In some embodiments, when the number of the at least one TRP is greater than or equal to 2, different TRPs in the at least one TRP are configured with different sets of reference signals, and/or different TRPs in the at least one TRP are configured with different resources, and/or different TRPs in the at least one TRP correspond to different hybrid automatic repeat requests (HARQ) processes, and/or different TRPs in the at least one TRP correspond to different protocol stacks.

In some embodiments, the protocol stack includes at least one of the following:

a service data adaptation protocol (SDAP) layer, a packet data convergence protocol (PDCP) layer, a radio link control (RLC) layer, a media access control (MAC) layer, and a physical (PHY) layer.

In the embodiments of the present disclosure, the network device may pre-configure a plurality of TRPs to the terminal device and activate or de-activate the TRPs in real time based on mobility of the terminal device.

In some embodiments, after activating the first TRP, the terminal device performs at least one of the following:
starting or restarting a timer corresponding to the first TRP;
performing a random access procedure;
performing the uplink synchronization process;
transmitting uplink data;
monitoring a downlink channel;
transmitting uplink reference signals; and
measuring and reporting downlink reference signals.

In some embodiments, the terminal device de-activates the first TRP in response to a second condition being satisfied. The second condition includes at least one of the following: a timer corresponding to the first TRP being timed out; indication information that is configured to indicate de-activating the first TRP being received; the channel quality of the first TRP being less than the first threshold.

That is, after the first TRP is activated, the timer corresponding to the first TRP is started or restarted, and the terminal device de-activates the first TRP in response to the timer corresponding to the first TRP being timed out.

In some embodiments, the first TRP is a primary TRP of the terminal device, and the terminal device activates a second TRP in response to the second condition being satisfied, where the second TRP is a secondary TRP of the terminal device. The terminal device de-activates the first TRP. The terminal device updates the second TRP to be the primary TRP of the terminal device. The second condition includes at least one of the following: the timer corresponding to the first TRP being timed out; the indication information that is configured to indicate de-activating the first TRP being received; the channel quality of the first TRP being less than the first threshold.

In some embodiments, the timer being timed out may be expressed as the timer being expired, which is not limited herein.

In some embodiments, the indication information configured to indicate de-activating the first TRP is further configured to indicate the terminal device to update the second TRP to be the primary TRP of the terminal device.

Specifically, when the terminal device needs to switch from the first TRP to the second TRP, the network device may firstly activate the second TRP as the secondary TRP of the terminal device. Further, the terminal device de-activates the first TRP, and subsequently, updates the second TRP as the primary TRP. In this way, the switching from the first TRP to the second TRP is completed.

In some embodiments, the network device may determine the first TRP as the primary TRP of the terminal device when configuring the at least one TRP. That is, the at least one TRP configured by the network device includes the primary TRP and the secondary TRP.

In the embodiments of the present disclosure, a data-interruption time length caused by the terminal device switching from the first TRP to the second TRP may be optimally reduced.

In some embodiments, the indication information configured to indicate de-activating the first TRP is determined based on a channel measurement result for the at least one TRP that is reported by the terminal device.

In some embodiments, after de-activating the first TRP, the terminal device performs at least one of the following:
stopping or resetting the timer corresponding to the first TRP;
releasing or deleting the resource configuration associated with the first TRP;
stopping transmitting the uplink data;
stopping receiving the downlink data;
suspending the MAC entity;
stopping measuring the downlink reference signals;
stopping reporting the measurement result for the downlink reference signals.

In some embodiments, the indication information configured to indicate de-activating the first TRP is carried via DCI or an MAC CE. In some embodiments, the DCI or the MAC CE further includes at least one of: a service cell identifier, a BWP identifier, an identifier of the first TRP, and beam information corresponding to the first TRP. For example, the beam information includes at least one of the following: a TCI state, an SSB, a CSI-RS, an SRS.

Therefore, in the embodiments of the present disclosure, the terminal device activates the first TRP of the at least one TRP in response to receiving the indication information configured to indicate de-activating the first TRP. Alternatively, the terminal device activates the first TRP of the at least one TRP in response to the channel quality of the first TRP being greater than or equal to the first threshold. That is, in the present disclosure, the terminal device may activate or de-activate the TRP, and therefore, the delay caused by signaling interactions during the switching triggering process may be reduced, and data interruption caused by the switching may be avoided.

Embodiments of the terminal device of the present disclosure is described in detail in the above by referring to FIG. 3. Embodiments of the network device of the present disclosure will be described in detail in the following by referring to FIG. 4. It should be understood that the embodiments of the network device and the embodiments of the terminal device correspond to each other, and similar descriptions may be referred to the terminal device.

FIG. 4 is a flow chart of a wireless communication method 300 according to an embodiment of the present disclosure, as shown in FIG. 4, the wireless communication method 300 may include at least some of the following.

In an operation S310, the network device sends first indication information to the terminal device. The first indication information is configured to indicate the terminal device to activate the first TRP of the at least one TRP.

In the present embodiment, the network device may indicate the terminal device to activate the first TRP of the at least one TRP.

In some embodiments, the first indication information is determined based on channel measurement result for the at least one TRP that is reported by the terminal device.

In some embodiments, in response to the channel quality of the first TRP being greater than or equal to the first threshold, the network device sends the first indication information to the terminal device.

In some embodiments, the first threshold is configured by the network device or determined by the protocol.

In some embodiments, the first indication information is carried via the DCI or the MAC CE. In some embodiments, the DCI or the MAC CE further includes at least one of: the service cell identifier, the BWP identifier, the identifier of the first TRP, and beam information corresponding to the first TRP. In some embodiments, the beam information comprises at least one of the following: the TCI state, the SSB, the CSI-RS, and the SRS.

That is, in the present embodiment, the indication information may be carried via the underlying signaling having less delay and more flexibility.

In some embodiments, the at least one TRP may be configured by the network device.

In some embodiments, the network device sends the first information to the terminal device. The first information includes: configuration information of the at least one TRP and/or state information of the at least one TRP. The state information is configured to indicate that a corresponding TRP is initially in an activated state or in a de-activated state after the configuration.

Specifically, for example, the state information may be as shown in Table 1, which is only one form of showing the state information, and the state information may alternatively be represented in another manner similar to that in the Table 1, which is not limited herein.

TABLE 1

| TRP identifier | Initial state |
|---|---|
| 0 | Activated |
| 1 | De-activated |
| 2 | De-activated |
| . . . | . . . |
| N − 1 | De-activated |

In some embodiments, the first information may be carried via one of the following:
the RRC, the DCI, and the MAC CE.

For example, the first information may occupy one or more elements in the signaling that carries the first information. Alternatively, the first information may occupy one or more fields in the signaling that carries the first information. Alternatively, the first information may occupy one or more domains in the signaling that carries the first information.

In some embodiments, in response to the configuration information of the at least one TRP including TA configuration, the terminal device may omit the uplink synchronization process after activating the first TRP.

In some embodiments, the terminal device performs channel quality monitoring on the configured at least one TRP. In some embodiments, the terminal device reports the channel quality of the at least one TRP.

In some embodiments, the terminal device performs channel quality monitoring and channel quality reporting based on the configuration of the network device.

For example, the network device may configure a measurement object (reference signals, the cell identifier, and so on), a reporting time and a reporting period. In some embodiments, the measurement result for the at least one TRP may be an RSRQ, an RSRP, and an SINR.

In some embodiments, when the number of the at least one TRP is greater than or equal to 2, different TRPs in the at least one TRP belong to different cells; alternatively, different TRPs in the at least one TRP belong to a same cell; alternatively, different TRPs in the at least one TRP correspond to different cell identifiers; alternatively, different TRPs in the at least one TRP correspond to a same cell identifier.

For example, the cell identifier is a physical cell identifier (PCI).

In some embodiments, when the number of the at least one TRP is greater than or equal to 2, different TRPs in the at least one TRP are configured with different sets of reference signals; and/or different TRPs in the at least one TRP are configured with different resources; and/or different TRPs in the at least one TRP correspond to different hybrid automatic repeat requests (HARQ) processes; and/or different TRPs in the at least one TRP correspond to different protocol stacks. In some embodiments, the protocol stack includes at least one of the following: an SDAP layer, a PDCP layer, an RLC layer, an MAC layer, and a PHY layer.

In the present embodiment, the network device may pre-configure a plurality of TRPs to the terminal device and activate or de-activate the TRPs in real time based on the mobility of the terminal device.

In some embodiments, the network device sends a second indication information to the terminal device, and the second indication information is configured to indicate the terminal device to de-activate the first TRP. In some embodiments, the first TRP is the primary TRP of the terminal device, and the second indication information is further configured to indicate the terminal device to update the second TRP to be the primary TRP of the terminal device. In some embodiments, the network device may indicate the first TRP to be the primary TRP of the terminal device when configuring the at least one TRP. That is, the at least one TRP configured by the network device includes the primary TRP and the secondary TRP.

Specifically, when the terminal device needs to switch from the first TRP to the second TRP, the network device may firstly activate the second TRP as the secondary TRP of the terminal device. Further, the terminal device de-activates the first TRP, and subsequently, updates the second TRP to be the primary TRP. In this way, the switching from the first TRP to the second TRP is completed.

In the embodiments of the present disclosure, the data-interruption time length caused by the terminal device switching from the first TRP to the second TRP may be optimally reduced.

In some embodiments, the second indication information is determined based on a channel measurement result that is performed for the at least one TRP and is reported by the terminal device.

In some embodiments, the network device sends the second indication information to the terminal device in response to the channel quality of the first TRP being less than the first threshold, or, in response to the timer corresponding to the first TRP being timed out. The timer corresponding to the first TRP is started or restarted when the first TRP is activated.

In some embodiments, this second indication information is carried via the DCI or the MAC CE. In some embodiments, the DCI or the MAC CE further includes at least one of: the service cell identifier, the BWP identifier, the identifier of the first TRP, and the beam information corresponding to the first TRP. In some embodiments, the beam information includes at least one of the following: a TCI state, an SSB, a CSI-RS, and an SRS.

Accordingly, in the present disclosure, the terminal device activates the first TRP of the at least one TRP in response to receiving an indication information configured to indicate activating of the first TRP. That is, in the present disclosure, the terminal device may activate or de-activate the TRP, such that the delay caused by signaling interactions during the switching triggering process may be reduced, and data interruption caused by the switching may be avoided.

The method embodiment of the present disclosure is described in detail in the above by referring to FIG. 3 and FIG. 4. Device embodiments of the present disclosure will be described in detail below by referring to FIGS. 5 to 9. It should be understood that the device embodiment and the method embodiment correspond to each other, similar descriptions may be referred to the method embodiment.

FIG. 5 is a schematic view of a terminal device 400 according to an embodiment of the present disclosure. As shown in FIG. 5, the terminal device 400 includes a processing unit 410.

The processing unit 410 activates the first TRP of the at least one TRP in response to the first condition being satisfied.

The first condition includes at least one of: the indication information that is configured to indicate activating the first TRP being received; and the channel quality of the first TRP being greater than or equal to the first threshold.

In some embodiments, the indication information that is configured to indicate activating the TRP is determined based on the channel measurement result for the at least one TRP that is reported by the terminal device.

In some embodiments, after activating the first TRP, the terminal device performs at least one of the following:
starting or restarting the timer corresponding to the first TRP;
performing the random access procedure;
performing the uplink synchronization process;
transmitting uplink data;
monitoring a downlink channel;
transmitting uplink reference signals; and
measuring and reporting downlink reference signals.

In some embodiments, the indication information that is configured to indicate activating the first TRP is carried via the DCI or the MAC CE.

In some embodiments, the processing unit 410 de-activates the first TRP in response to the second condition being satisfied.

The second condition includes at least one of the following: the timer corresponding to the first TRP being timed out; the indication information that is configured to indicate de-activating the first TRP being received; the channel quality of the first TRP being less than the first threshold.

In some embodiments, the first TRP is the primary TRP of the terminal device, and in response to the second condition being satisfied:
the processing unit 410 activates the second TRP, where the second TRP is the secondary TRP of the terminal device;
the processing unit 410 de-activates the first TRP; and
the processing unit 410 device updates the second TRP to be the primary TRP of the terminal device.

The second condition includes at least one of the following: the timer corresponding to the first TRP being timed out; the indication information configured to indicate de-activating the first TRP being received; and the channel quality of the first TRP being less than the first threshold.

In some embodiments, the indication information configured to indicate de-activating the first TRP is further configured to indicate the terminal device to update the second TRP to be the primary TRP of the terminal device.

In some embodiments, the indication information configured to indicate de-activating the first TRP is determined based on the channel measurement result for the at least one TRP that is reported by the terminal device.

In some embodiments, after de-activating the first TRP, the processing unit 410 performs at least one of the following:
stopping or resetting the timer corresponding to the first TRP;
releasing or deleting the resource configuration associated with the first TRP;
stopping transmitting the uplink data;
stopping receiving the downlink data;
suspending the MAC entity;
stopping measuring the downlink reference signals;
stopping reporting the measurement result for the downlink reference signals.

In some embodiments, the indication information configured to indicate de-activating the first TRP is carried via the DCI or the MAC CE.

In some embodiments, the DCI or the MAC CE further includes at least one of: the service cell identifier, the BWP identifier, the identifier of the first TRP, and the beam information corresponding to the first TRP.

The beam information includes at least one of the following: the TCI state, the SSB, the CSI-RS, the SRS.

In some embodiments, when the number of the at least one TRP is greater than or equal to 2, different TRPs in the at least one TRP belong to different cells. Alternatively, different TRPs in the at least one TRP belong to a same cell. Alternatively, different TRPs in the at least one TRP correspond to different cell identifiers. Alternatively, different TRPs in the at least one TRP correspond to a same cell identifier.

In some embodiments, when the number of the at least one TRP is greater than or equal to 2, different TRPs in the at least one TRP are configured with different sets of reference signals; and/or different TRPs in the at least one TRP are configured with different resources; and/or different TRPs in the at least one TRP correspond to different hybrid automatic repeat requests (HARQ) processes; and/or different TRPs in the at least one TRP correspond to different protocol stacks.

In some embodiments, the protocol stack includes at least one of the following:
the service data adaptation protocol (SDAP) layer, the packet data convergence protocol (PDCP) layer, the radio link control (RLC) layer, the media access control (MAC) layer, and the physical (PHY) layer.

In some embodiments, the terminal device 400 further includes:
a communication unit 420, configured to receive the first information.

The first information includes: configuration information of the at least one TRP and/or state information of the at least one TRP. The state information is configured to indicate that a corresponding TRP is initially in the activated state or in the de-activated state after the configuration.

In some embodiments, the above-described communication unit may be a communication interface or a transceiver; or an input/output interface of a communication chip or a system-on-chip. The processing unit described in the above may be one or more processors.

It should be understood that the terminal device 400 according to the embodiments of the present disclosure may correspond to the terminal device in the method embodiments of the present disclosure. The above and other operations and/or functions of various units in the terminal device 400 are respectively configured to perform corresponding processes of the terminal device in the method 200 shown in FIG. 3, which will not be repeated herein for the brevity.

FIG. 6 is a schematic view of a network device 500 according to an embodiment of the present disclosure. As shown in FIG. 6, the network device 500 includes the following.

A communication unit 510 is configured to send the first indication information to the terminal device. The first indication information is configured to indicate the terminal device to activate the first TRP of the at least one TRP.

In some embodiments, the first indication information is determined based on the channel measurement result for the at least one TRP that is reported by the terminal device.

In some embodiments, in response to the channel quality of the first TRP being greater than or equal to the first threshold, the communication unit 510 is configured to send the first indication information to the terminal device.

In some embodiments, the first indication information is carried via the DCI or the MAC CE.

In some embodiments, the communication unit 510 is further configured to send the second indication information to the terminal device, and the second indication information is configured to indicate the terminal device to de-activate the first TRP.

In some embodiments, the first TRP is the primary TRP of the terminal device, and the second indication information is further configured to indicate the terminal device to update the second TRP to be the primary TRP of the terminal device.

In some embodiments, the second indication information is determined based on the channel measurement result for the at least one TRP that is reported by the terminal device.

In some embodiments, the communication unit 510 is configured to:
send the second indication information to the terminal device in response to the channel quality of the first TRP being less than the first threshold, or, in response to the timer corresponding to the first TRP being timed out.

The timer corresponding to the first TRP is started or restarted when the first TRP is activated.

In some embodiments, the second indication information is carried via the DCI or the MAC CE.

In some embodiments, the DCI or the MAC CE further includes at least one of: the service cell identifier, the BWP identifier, the identifier of the first TRP, and beam information corresponding to the first TRP.

In some embodiments, the beam information includes at least one of the following: the TCI state, the SSB, the CSI-RS, and the SRS.

In some embodiments, when the number of the at least one TRP is greater than or equal to 2, different TRPs in the at least one TRP belong to different cells; alternatively, different TRPs in the at least one TRP belong to a same cell; alternatively, different TRPs in the at least one TRP correspond to different cell identifiers; alternatively, different TRPs in the at least one TRP correspond to a same cell identifier.

In some embodiments, when the number of the at least one TRP is greater than or equal to 2, different TRPs in the at least one TRP are configured with different sets of reference signals; and/or different TRPs in the at least one TRP are configured with different resources; and/or different TRPs in the at least one TRP correspond to different hybrid automatic repeat requests (HARQ) processes; and/or different TRPs in the at least one TRP correspond to different protocol stacks

In some embodiments, the protocol stack includes at least one of the following:
the SDAP layer, the PDCP layer, the RLC layer, the MAC layer, and the PHY layer.

In some embodiments, the communication unit 510 is further configured to receive the first information to the terminal device.

The first information includes: configuration information of the at least one TRP and/or state information of the at least one TRP. The state information is configured to indicate that the corresponding TRP is initially in the activated state or in the de-activated state after the configuration.

In some embodiments, the above-described communication unit may be a communication interface or a transceiver; or an input/output interface of a communication chip or a system-on-chip. The processing unit described in the above may be one or more processors.

It should be understood that the network device 500 according to the embodiments of the present disclosure may correspond to the network device in the method embodiments of the present disclosure. The above and other operations and/or functions of various units in the network device 500 are respectively configured to perform corresponding processes of the network device in the method 300 shown in FIG. 4, which will not be repeated herein for the brevity.

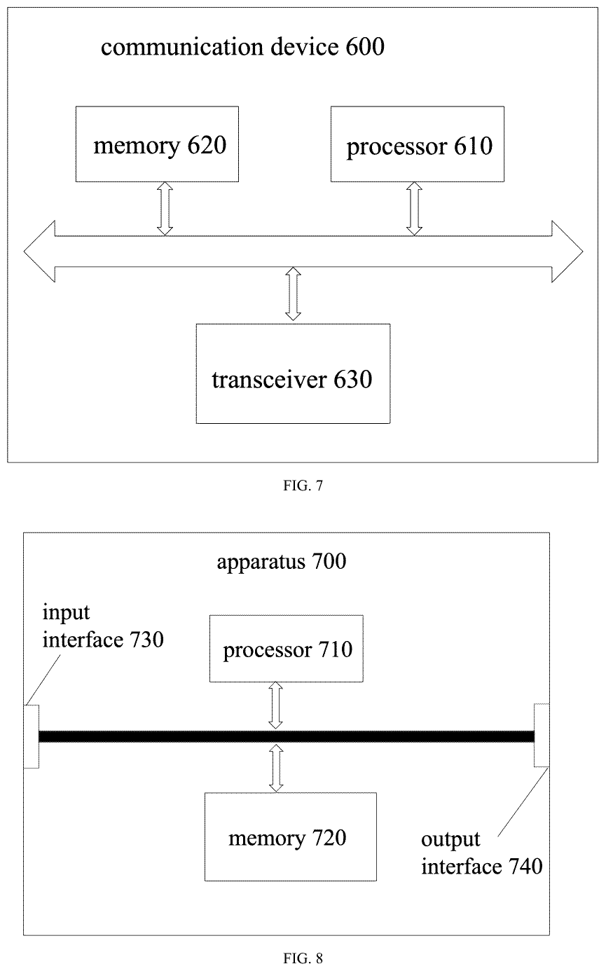

FIG. 7 is a schematic view of a communication device 600 according to the embodiments of the present disclosure. The communication device 600 shown in FIG. 7 includes a processor 610. The processor 610 may invoke and run a computer program from a memory to implement the method in the embodiments of the present disclosure.

In some embodiments, as shown in FIG. 7, the communication device 600 may further include a memory 620. The processor 610 may invoke and run the computer program from the memory 620 to implement the method in the embodiment of the present disclosure.

The memory 620 may be a component separated from the processor 610 or may be integrated into the processor 610.

In some embodiments, as shown in FIG. 7, the communication device 600 may further include a transceiver 630. The processor 610 may control the transceiver 630 to communicate with other devices, specifically, to send information or data to other devices or to receive information or data sent by other devices.

The transceiver 630 may include a transmitter and a receiver. The transceiver 630 may further include an antenna, and the number of antennas may be one or more.

In some embodiments, the communication device 600 may specifically be the network device of the embodiments of the present disclosure. The communication device 600 may perform the corresponding processes performed by the network device in the various method embodiments of the present disclosure, which will not be repeated herein.

In some embodiments, the communication device 600 may specifically be the terminal device of the embodiments of the present disclosure. The communication device 600 may perform the corresponding processes performed by the terminal device in the various method embodiments of the present disclosure, which will not be repeated herein.

FIG. 8 is a schematic view of an apparatus according to an embodiment of the present disclosure. The apparatus 700 shown in FIG. 8 includes a processor 710. The processor 710 may invoke and run a computer program from a memory to perform the methods of the embodiments of the present disclosure.

In some embodiments, as shown in FIG. 8, the apparatus 700 may further include a memory 720. The processor 710 may invoke and run the computer program from the memory 720 to implement the method in the embodiments of the present disclosure.

The memory 720 may be a component separated from the processor 710 or may be integrated into the processor 710.

In some embodiments, the apparatus 700 may further include an input interface 730. The processor 710 may control the input interface 730 to communicate with other devices or chips, specifically, to obtain information or data sent by other devices or chips.

In some embodiments, the apparatus 700 may further include an output interface 740. The processor 710 may control the output interface 740 to communicate with other devices or chips, specifically, to output information or data to other devices or chips.

In some embodiments, the apparatus may be applied to the network device in the embodiments of the present disclosure, and the apparatus may perform the corresponding processes performed by the network device in various method embodiments of the present disclosure, which will not be repeated herein.

In some embodiments, the apparatus may be applied to the terminal device in the embodiments of the present application, and the apparatus may perform the corresponding processes performed by the terminal device in various method embodiments of the present disclosure, which are not repeated herein.

In some embodiments, the apparatus referred to in the embodiments of the present disclosure may alternatively be a chip. For example, the apparatus may be a system-on-chip, a systemic chip, a chip system or an on-chip systemic chip, and so on.

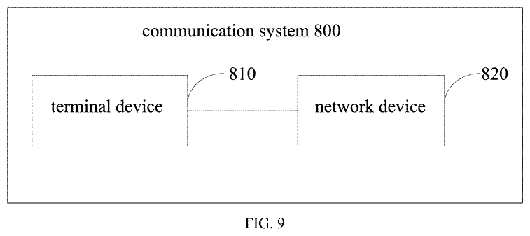

FIG. 9 is a schematic view of a communication system 800 provided by embodiments of the present disclosure. As shown in FIG. 9, the communication system 800 includes a terminal device 810 and a network device 820.

The terminal device 810 may be configured to achieve corresponding functions achieved by the terminal device in the method described above, and the network device 820 may be configured to achieve corresponding functions achieved by the network device in the method described above, which will not be repeated herein.

It should be understood that the processor in the embodiment of the present disclosure may be an integrated circuit chip having signal processing capabilities. In realization, the operations of the above method embodiments may be achieved by integrated logic circuits of hardware in the processor or by instructions in the form of software. The above-described processor may be a general-purpose processor, a digital signal processor (DSP), an application specific integrated circuit (ASIC), a field programmable gate array (FPGA), or other programmable logic devices, a discrete gate or a transistor logic device, and a discrete hardware component. The processor may perform the various methods, operations, and logic block diagrams in the embodiments of the present disclosure. The general purpose processor may be a microprocessor or any conventional processor. The operations in the method disclosed by referring to the embodiments of the present disclosure may be directly embodied as being performed by a hardware decoding processor or performed by a combination of hardware and a software module in a decoding processor. The software module may be located in a random memory, flash memory, a read-only memory, a programmable read-only memory or an electrically erasable programmable memory, a register, and other storage media that are well established in the art. The storage medium is located in the memory, and the processor reads information in the memory and completes the operations of the method described in the above cooperatively with its hardware.

It is understood that the memory in the embodiments of the present disclosure may be a volatile memory or a non-volatile memory, or include both the volatile and the non-volatile memory. The non-volatile memory may be a read-only memory (ROM), a programmable ROM (PROM), an erasable programmable read-only memory (EPROM), an electrically erasable programmable read-only memory (EEPROM), or a flash memory. The volatile memory may be a random access memory (RAM), which is used as an external cache. As an illustrative example instead of a limitation, various forms of the RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SDRAM), and a direct rambus RAM (DRAM). It should be noted that the memory of the systems and methods described herein includes, but is not limited to, the above memories and any other suitable types of memories.

It should be understood that the above memories are exemplary but not limiting descriptions. For example, the memories in the embodiments of the present disclosure may alternatively be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DRAM). That is, the memory of the present disclosure includes, but is not limited to, the above memories and any other suitable types of memories.

The present disclosure further provides a computer-readable storage medium for storing a computer program.

In some embodiments, the computer-readable storage medium may be applied to the network device in the embodiments of the present disclosure, and the computer program causes the computer to execute the corresponding processes performed by the network device in the various method embodiments of the present disclosure, which will not be repeated herein.

In some embodiments, the computer-readable storage medium may be applied to the terminal device in the embodiments of the present disclosure, and the computer program causes the computer to perform the corresponding processes performed by the terminal device in the method embodiments of the present disclosure, which are not repeated herein.

The present disclosure further provides a computer program product including computer program instructions.

In some embodiments, the computer program product may be applied to the network device in the embodiments of the present disclosure, and the computer program instructions cause the computer to execute the corresponding processes performed by the network device in the various method embodiments of the present disclosure, which are not repeated herein.

In some embodiments, the computer program product may be applied to the terminal device in the embodiments of the present disclosure, and the computer program instructions cause the computer to perform the corresponding processes performed by the terminal device in the method embodiments of the present disclosure, which are not repeated herein.

The present disclosure further provides a computer program.

In some embodiments, the computer program may be applied to the network device in the embodiments of the present disclosure, and when the computer program is run on the computer, the computer is caused to execute the corresponding processes performed by the network device in the various method embodiments of the present disclosure, which are not repeated herein.

In some embodiments, the computer program may be applied to the terminal device in the embodiments of the present disclosure, and when the computer program is run on a computer, the computer is caused to execute the corresponding processes performed by the terminal device in the various method embodiments of the present disclosure, which are not repeated herein.

Any ordinary skilled person in the art may realize that units and algorithmic operations of the various embodiments disclosed herein can be implemented in electronic hardware, or in a combination of computer software and electronic hardware. Whether these functions are achieved in hardware or in software depends on particular applications and design constraints of the technical solution. Any ordinary skilled person in the art may use different methods to implement the described functions for each particular application, but such implementations shall not be considered outside the scope of the present disclosure.

It is clear to any ordinary skilled person in the art, for convenience and brevity of the description, specific operation processes of the above-described systems, devices, and units can be referred to the corresponding processes in the method embodiments, which will not be repeated herein.

In various embodiments provided in the present disclosure, it should be understood that the systems, the devices and the methods can be achieved in other ways. For example, the device embodiments described in the above are merely schematic. For example, the units are divided based on logical functions, and in practice, the units may be divided in other ways. For example, a plurality of units or components may be combined with each other or may be integrated into another system, or some features may be omitted or not implemented. Furthermore, coupling or direct coupling or communicative connection between each other may be indirect coupling or communicative connection through some interfaces, devices or units, and may be electric coupling, mechanical coupling or coupling in other forms.

Units that are illustrated as separated components may be or may not be physically separated from each other, and components displayed as units may be or may not be physical units. That is, the units may be located at one place, or may be distributed to a plurality of network units. Some or all of these units may be selected to fulfill the purpose of the embodiments according to actual demands.

In addition, various functional units in various embodiments of the present disclosure may be integrated in one processing unit, or each of the functional units may be physically present separately from each other, or two or more units may be integrated in one unit.

When the functions are achieved in the form of a software functional unit and sold or used as a stand-alone product, the functions may be stored in a computer-readable storage medium. It is thus understood that the essence of the technical solution of the present disclosure, or a portion of the technical solution that contributes to the art, or a portion of the technical solution may be embodied in the form of a software product. The software product is stored in a storage medium and includes a number of instructions to cause a computer device (which may be a personal computer, a server, or a network device, and so on) to perform all or part of the operations of the method described in the various embodiments of the present disclosure. The above-mentioned storage medium includes a USB flash drive, a removable hard disk, a read-only memory (ROM), a random access memory (RAM), a magnetic disk, an optical disk, and other media that can store program codes.

The above describes only specific embodiments of the present disclosure, but the scope of the present disclosure is not limited thereto. Any ordinary skilled person in the art may perform changes or substitutions on the embodiments, and the changes and the substitutions shall be within the scope of the present disclosure. Therefore, the scope of the present disclosure shall be determined by the scope of the claims.

What is claimed is:

1. A wireless communication method, comprising:
activating, by a terminal device, a first transmission reception point (TRP) of at least one TRP in response to a first condition being satisfied;
wherein the first condition comprises at least one of:
indication information that is configured to indicate activating the first TRP being received; and
channel quality of the first TRP being greater than or equal to a first threshold.

2. The wireless communication method according to claim 1, wherein the indication information that is configured to indicate activating the first TRP is determined based on a channel measurement result for the at least one TRP that is reported by the terminal device.

3. The wireless communication method according to claim 1, further comprising:
after activating the first TRP, performing, by the terminal device, at least one of the following:
starting or restarting a timer corresponding to the first TRP;
performing a random access procedure;
performing an uplink synchronization process;
transmitting uplink data;
monitoring a downlink channel;
transmitting uplink reference signals; and
measuring and reporting downlink reference signals.

4. The wireless communication method according to claim 1, wherein the indication information that is configured to indicate activating the first TRP is carried via downlink control information (DCI) or a media access control control element (MAC CE).

5. The wireless communication method according to claim 4, wherein the DCI or the MAC CE further comprises at least one of: a service cell identifier, a band width part (BWP) identifier, an identifier of the first TRP, and beam information corresponding to the first TRP.

6. The wireless communication method according to claim 5, wherein the beam information comprises at least one of the following: a transmission configuration indicator (TCI) state, a synchronization signal block (SSB), a channel state information reference signal (CSI-RS), and a sounding reference signal (SRS).

7. The wireless communication method according to claim 1, wherein in response to the number of the at least one TRP being greater than or equal to 2, different TRPs in the at least one TRP belong to different cells, or different TRPs in the at least one TRP belong to a same cell, or different TRPs in the at least one TRP correspond to different cell identifiers, or different TRPs in the at least one TRP correspond to a same cell identifier.

8. The wireless communication method according to claim 1, wherein, in response to the number of the at least one TRP being greater than or equal to 2, different TRPs in the at least one TRP are configured with different sets of reference signals, and/or different TRPs in the at least one TRP are configured with different resources, and/or different TRPs in the at least one TRP correspond to different hybrid automatic repeat requests (HARQ) processes, and/or different TRPs in the at least one TRP correspond to different protocol stacks.

9. A terminal device, comprising: a processor and a memory, wherein the memory is configured to store a computer program, the processor is configured to invoke and run the computer program stored in the memory to perform operations of:
activating a first transmission reception point (TRP) of at least one TRP in response to a first condition being satisfied;
wherein the first condition comprises at least one of:
indication information that is configured to indicate activating the first TRP being received; and
channel quality of the first TRP being greater than or equal to a first threshold.

10. The terminal device according to claim 9, wherein the indication information that is configured to indicate activating the first TRP is determined based on a channel measurement result for the at least one TRP that is reported by the terminal device.

11. The terminal device according to claim 9, after activating the first TRP, the processor is configured to invoke and run the computer program stored in the memory to perform at least one of the following:
starting or restarting a timer corresponding to the first TRP;
performing a random access procedure;
performing an uplink synchronization process;
transmitting uplink data;
monitoring a downlink channel;
transmitting uplink reference signals; and
measuring and reporting downlink reference signals.

12. The terminal device according to claim 9, wherein the indication information that is configured to indicate activating the first TRP is carried via downlink control information (DCI) or a media access control control element (MAC CE).

13. The terminal device according to claim 12, wherein the DCI or the MAC CE further comprises at least one of: a service cell identifier, a band width part (BWP) identifier, an identifier of the first TRP, and beam information corresponding to the first TRP.

14. The terminal device according to claim 13, wherein the beam information comprises at least one of the following: a transmission configuration indicator (TCI) state, a synchronization signal block (SSB), a channel state information reference signal (CSI-RS), and a sounding reference signal (SRS).

15. The terminal device according to claim 9, wherein in response to the number of the at least one TRP being greater than or equal to 2, different TRPs in the at least one TRP belong to different cells, or different TRPs in the at least one TRP belong to a same cell, or different TRPs in the at least one TRP correspond to different cell identifiers, or different TRPs in the at least one TRP correspond to a same cell identifier.

16. The terminal device according to claim 9, wherein, in response to the number of the at least one TRP being greater than or equal to 2, different TRPs in the at least one TRP are configured with different sets of reference signals, and/or different TRPs in the at least one TRP are configured with different resources, and/or different TRPs in the at least one TRP correspond to different hybrid automatic repeat requests (HARQ) processes, and/or different TRPs in the at least one TRP correspond to different protocol stacks.

17. A network device, comprising: a processor and a memory, wherein the memory is configured to store a computer program, the processor is configured to invoke and run the computer program stored in the memory to perform operations of:
sending first indication information to a terminal device, wherein the first indication information is configured to indicate the terminal device to activate a first transmission reception point (TRP) of at least one TRP.

18. The network device according to claim 17, wherein the first indication information is determined based on a channel measurement result for the at least one TRP that is reported by the terminal device.

19. The network device according to claim 17, wherein the first indication information is carried via downlink control information (DCI) or a media access control control element (MAC CE).

20. The network device according to claim 19, wherein the DCI or the MAC CE further comprises at least one of: a service cell identifier, a band width part (BWP) identifier, an identifier of the first TRP, and beam information corresponding to the first TRP.
